(19) United States
(12) Patent Application Publication
(10) Pub. No.: US 2025/0024446 A1
(43) Pub. Date: Jan. 16, 2025

(54) PHYSICAL DOWNLINK SHARED CHANNEL DEFAULT BEAM SELECTION

(71) Applicant: QUALCOMM Incorporated, San Diego, CA (US)

(72) Inventors: Mostafa KHOSHNEVISAN, San Diego, CA (US); Yitao CHEN, San Marcos, CA (US); Jing SUN, San Diego, CA (US); Peter GAAL, San Diego, CA (US); Tao LUO, San Diego, CA (US); Fang YUAN, Beijing (CN)

(21) Appl. No.: 18/712,868

(22) PCT Filed: Jan. 12, 2022
(86) PCT No.: PCT/CN2022/071521

§ 371 Date: May 23, 2024

(51) Int. Cl. H04W 72/044; H04L 5/00; H04W 72/23

(52) U.S. Cl. CPC H04W 72/046; H04L 5/0091; H04W 72/23

(57) ABSTRACT

Various aspects of the present disclosure generally relate to wireless communication. In some aspects, a user equipment (UE) may receive an indication of a pair of transmission configuration indication (TCI) states associated with a physical downlink shared channel (PDSCH). The UE may select, based at least in part on the indication, a default beam for receiving information via the PDSCH. Numerous other aspects are described.

### FIELD OF THE DISCLOSURE

Aspects of the present disclosure generally relate to wireless communication and to techniques and apparatuses for physical downlink shared channel default beam selection.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Tenn Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more base stations that support communication for a user equipment (UE) or multiple UEs. A UE may communicate with a base station via downlink communications and uplink communications. “Downlink” (or “DL”) refers to a communication link from the base station to the UE, and “uplink” (or “UL”) refers to a communication link from the UE to the base station.

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by a user equipment (UE). The method may include receiving an indication of a pair of transmission configuration indication (TCI) states associated with a physical downlink shared channel (PDSCH). The method may include selecting, based at least in part on the indication, a default beam for receiving information via the PDSCH.

Some aspects described herein relate to an apparatus for wireless communication performed by a UE. The apparatus may include a memory and one or more processors, coupled to the memory. The one or more processors may be configured to receive an indication of a pair of TC states associated with a PDSCH. The one or more processors may be configured to select, based at least in part on the indication, a default beam for receiving information via the PDSCH.

Some aspects described herein relate to a non-transitory computer-readable medium that stores a set of instructions for wireless communication by a UE. The set of instructions, when executed by one or more processors of the UE, may cause the UE to receive an indication of a pair of TC states associated with a PDSCH. The set of instructions, when executed by one or more processors of the UE, may cause the UE to select, based at least in part on the indication, a default beam for receiving information via the PDSCH.

Some aspects described herein relate to an apparatus for wireless communication. The apparatus may include means for receiving an indication of a pair of TC states associated with a PDSCH. The apparatus may include means for selecting, based at least in part on the indication, a default beam for receiving information via the PDSCH.

Aspects generally include a method, apparatus, system, computer program product, non-transitory computer-readable medium, user equipment, base station, wireless communication device, and/or processing system as substantially described herein with reference to and as illustrated by the drawings.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a base station in communication with a user equipment (UE) in a wireless network, in accordance with the present disclosure.

FIG. 3 is a diagram illustrating an example of using beams for communications between a base station and a UE, in accordance with the present disclosure.

FIG. 4 is a diagram illustrating an example of communications using a multiple transmission reception point (TRP) scheme, in accordance with the present disclosure.

FIG. 5 is a diagram illustrating an example of communications using unified transmission configuration indication (TCI) in a single TRP scheme, in accordance with the present disclosure.

FIG. 6 is a diagram illustrating an example of communications using unified TCI in a multiple TRP scheme, in accordance with the present disclosure.

FIG. 7 is a diagram illustrating an example associated with physical downlink shared channel (PDSCH) default beam selection, in accordance with the present disclosure.

FIG. 8 is a diagram illustrating an example associated with default beam selection for a single beam PDSCH, in accordance with the present disclosure.

FIG. 9 is a diagram illustrating an example associated with default beam selection for a PDSCH pattern, in accordance with the present disclosure.

FIG. 10 is a diagram illustrating an example associated with beam selection for an intra-slot PDSCH scheme, in accordance with the present disclosure.

FIG. 11 is a diagram illustrating an example process associated with PDSCH default beam selection, in accordance with the present disclosure.

FIG. 12 is a diagram of an example apparatus for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

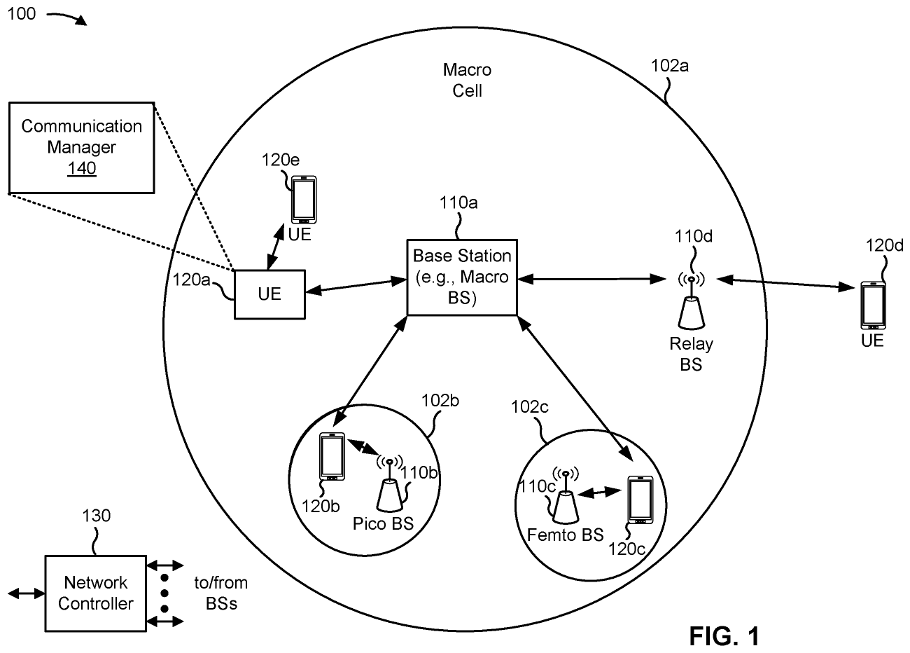

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more base stations 110 (shown as a BS 110a, a BS 110b, a BS 110c, and a BS 110d), a user equipment (UE) 120 or multiple UEs 120 (shown as a UE 120a, a UE 120b, a UE 120c, a UE 120d, and a UE 120e), and/or other network entities. A base station 110 is an entity that communicates with UEs 120. A base station 110 (sometimes referred to as a BS) may include, for example, an NR base station, an LTE base station, a Node B, an eNB (e.g., in 4G), a gNB (e.g., in 5G), an access point, and/or a transmission reception point (TRP). As described herein, a “single TRP” (sTRP) scheme may refer to a UE 120 communicating with a single TRP, while a “multi-TRP” (mTRP) scheme may refer to a UE 120 communicating with multiple TRPs. Each base station 110 may provide communication coverage for a particular geographic area. In the Third Generation Partnership Project (3GPP), the term “cell” can refer to a coverage area of a base station 110 and/or a base station subsystem serving this coverage area, depending on the context in which the term is used.

A base station 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (e.g., a home) and may allow restricted access by UEs 120 having association with the femto cell (e.g., UEs 120 in a closed subscriber group (CSG)). A base station 110 for a macro cell may be referred to as a macro base station. A base station 110 for a pico cell may be referred to as a pico base station. A base station 110 for a femto cell may be referred to as a femto base station or an in-home base station. In the example shown in FIG. 1, the BS 110a may be a macro base station for a macro cell 102a, the BS 110b may be a pico base station for a pico cell 102b, and the BS 110c may be a femto base station for a femto cell 102c. A base station may support one or multiple (e.g., three) cells.

In some examples, a cell may not necessarily be stationary, and the geographic area of the cell may move according to the location of a base station 110 that is mobile (e.g., a mobile base station). In some examples, the base stations 110 may be interconnected to one another and/or to one or more other base stations 110 or network nodes (not shown) in the wireless network 100 through various types of backhaul interfaces, such as a direct physical connection or a virtual network, using any suitable transport network.

The wireless network 100 may include one or more relay stations. A relay station is an entity that can receive a transmission of data from an upstream station (e.g., a base station 110 or a UE 120) and send a transmission of the data to a downstream station (e.g., a UE 120 or a base station 110). A relay station may be a UE 120 that can relay transmissions for other UEs 120. In the example shown in FIG. 1, the BS 110d (e.g., a relay base station) may communicate with the BS 110a (e.g., a macro base station) and the UE 120d in order to facilitate communication between the BS 110a and the UE 120d. A base station 110 that relays communications may be referred to as a relay station, a relay base station, a relay, or the like.

The wireless network 100 may be a heterogeneous network that includes base stations 110 of different types, such as macro base stations, pico base stations, femto base stations, relay base stations, or the like. These different types of base stations 110 may have different transmit power levels, different coverage areas, and/or different impacts on interference in the wireless network 100. For example, macro base stations may have a high transmit power level (e.g., 5 to 40 watts) whereas pico base stations, femto base stations, and relay base stations may have lower transmit power levels (e.g., 0.1 to 2 watts).

A network controller 130 may couple to or communicate with a set of base stations 110 and may provide coordination and control for these base stations 110. The network controller 130 may communicate with the base stations 110 via a backhaul communication link. The base stations 110 may communicate with one another directly or indirectly via a wireless or wireline backhaul communication link.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, and/or any other suitable device that is configured to communicate via a wireless medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a base station, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components.

In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the base station 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may receive an indication of a pair of transmission configuration indication (TCI) states associated with a physical downlink shared channel (PDSCH); and select, based at least in part on the indication, a default beam for receiving information via the PDSCH. Additionally, or alternatively, the communication manager 140 may perform one or more other operations described herein.

As indicated above, FIG. 1 is provided as an example. Other examples may differ from what is described with regard to FIG. 1.

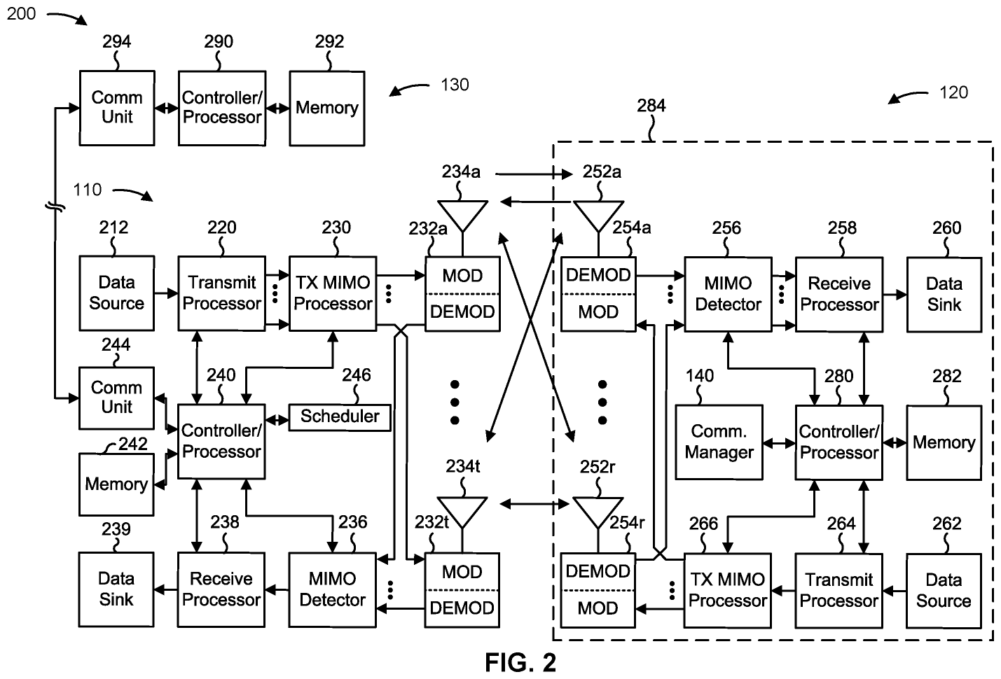

FIG. 2 is a diagram illustrating an example 200 of a base station 110 in communication with a UE 120 in a wireless network 100, in accordance with the present disclosure. The base station 110 may be equipped with a set of antennas 234a through 234t, such as T antennas (T≥1). The UE 120 may be equipped with a set of antennas 252a through 252r, such as R antennas (R≥1).

At the base station 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The base station 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the base station 110 and/or other base stations 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the base station 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

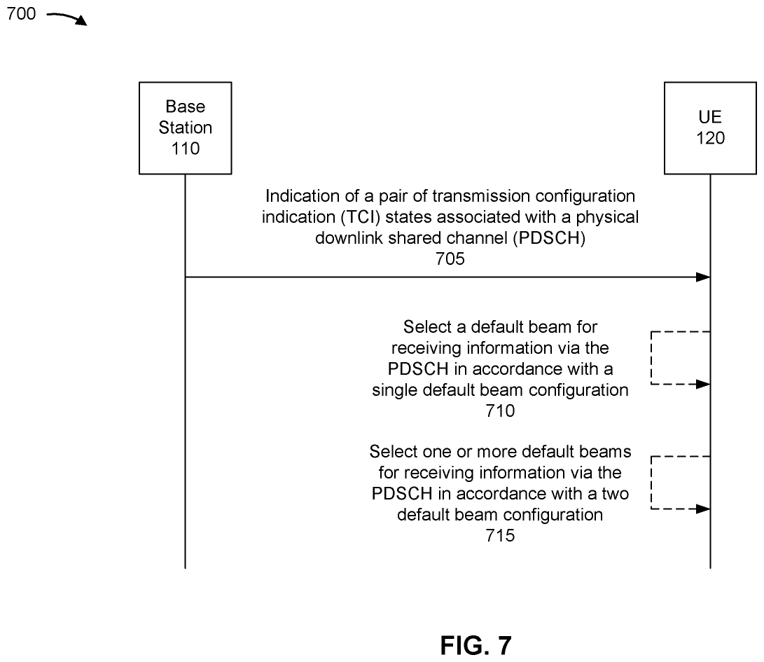

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the base station 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 7-12).

At the base station 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The base station 110 may include a communication unit 244 and may communicate with the network controller 130 via the communication unit 244. The base station 110 may include a scheduler 246 to schedule one or more UEs 120 for downlink and/or uplink communications. In some examples, the modem 232 of the base station 110 may include a modulator and a demodulator. In some examples, the base station 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 7-12).

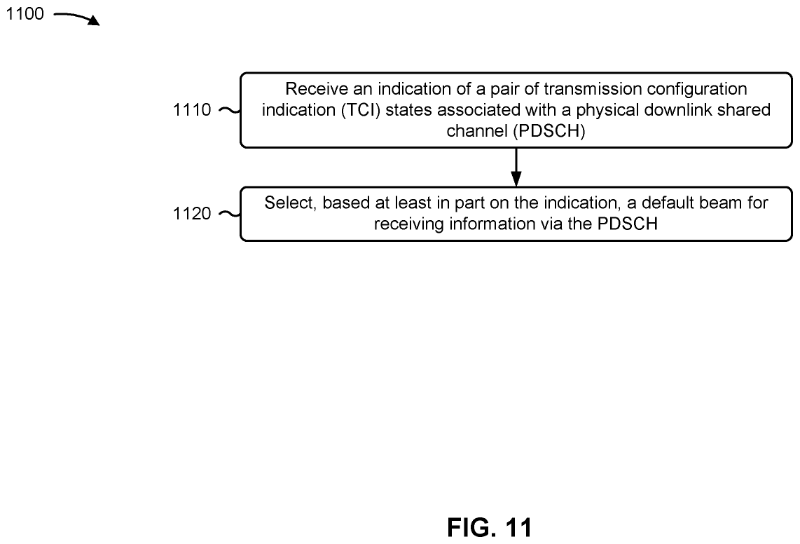

The controller/processor 240 of the base station 110, the controller/processor 280 of the UE 120, and/or any other component(s) of FIG. 2 may perform one or more techniques associated with PDSCH default beam selection, as described in more detail elsewhere herein. For example, the controller/processor 240 of the base station 110, the controller/processor 280 of the UE 120, and/or any other component(s) of FIG. 2 may perform or direct operations of, for example, process 1100 of FIG. 11, and/or other processes as described herein. The memory 242 and the memory 282 may store data and program codes for the base station 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the base station 110 and/or the UE 120, may cause the one or more processors, the UE 120, and/or the base station 110 to perform or direct operations of, for example, process 1100 of FIG. 11, and/or other processes as described herein. In some examples, executing instructions may include running the instructions, converting the instructions, compiling the instructions, and/or interpreting the instructions, among other examples.

In some aspects, the UE 120 includes means for receiving an indication of a pair of TCI states associated with a PDSCH; and/or means for selecting, based at least in part on the indication, a default beam for receiving information via the PDSCH. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

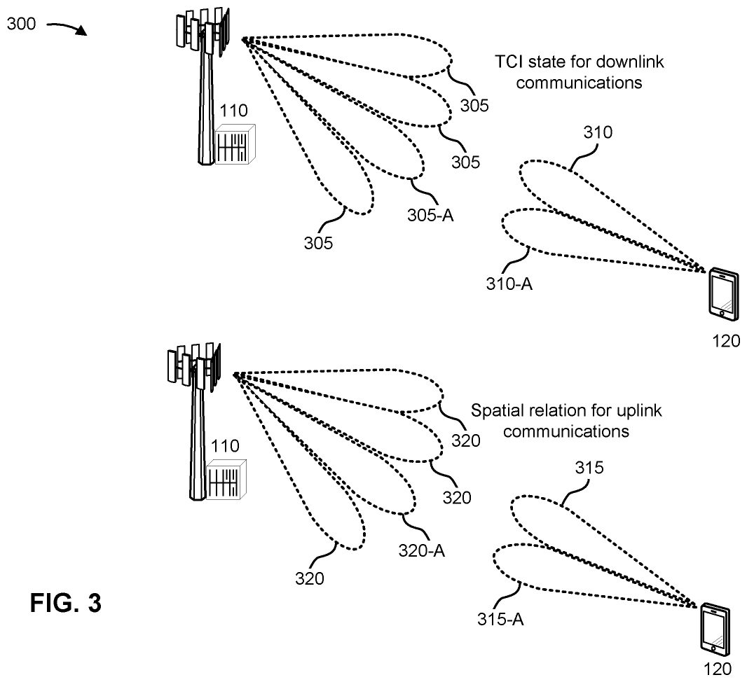

FIG. 3 is a diagram illustrating an example 300 of using beams for communications between a base station and a UE, in accordance with the present disclosure. As shown in FIG. 3, a base station 110 and a UE 120 may communicate with one another.

The base station 110 may transmit to UEs 120 located within a coverage area of the base station 110. The base station 110 and the UE 120 may be configured for beamformed communications, where the base station 110 may transmit in the direction of the UE 120 using a directional BS transmit beam, and the UE 120 may receive the transmission using a directional UE receive beam. Each BS transmit beam may have an associated beam ID, beam direction, or beam symbols, among other examples. The base station 110 may transmit downlink communications via one or more BS transmit beams 305.

The UE 120 may attempt to receive downlink transmissions via one or more UE receive beams 310, which may be configured using different beamforming parameters at receive circuitry of the UE 120. The UE 120 may identify a particular BS transmit beam 305, shown as BS transmit beam 305-A, and a particular UE receive beam 310, shown as UE receive beam 310-A, that provide relatively favorable performance (for example, that have a best channel quality of the different measured combinations of BS transmit beams 305 and UE receive beams 310). In some examples, the UE 120 may transmit an indication of which BS transmit beam 305 is identified by the UE 120 as a preferred BS transmit beam, which the base station 110 may select for transmissions to the UE 120. The UE 120 may thus attain and maintain a beam pair link (BPL) with the base station 110 for downlink communications (for example, a combination of the BS transmit beam 305-A and the UE receive beam 310-A), which may be further refined and maintained in accordance with one or more established beam refinement procedures.

A downlink beam, such as a BS transmit beam 305 or a UE receive beam 310, may be associated with a TCI state. A TCI state may indicate a directionality or a characteristic of the downlink beam, such as one or more quasi co-location (QCL) properties of the downlink beam. A QCL property may include, for example, a Doppler shift, a Doppler spread, an average delay, a delay spread, or spatial receive parameters, among other examples. In some examples, each BS transmit beam 305 may be associated with a synchronization signal block (SSB), and the UE 120 may indicate a preferred BS transmit beam 305 by transmitting uplink transmissions in resources of the SSB that are associated with the preferred BS transmit beam 305. A particular SSB may have an associated TCI state (for example, for an antenna port or for beamforming). The base station 110 may, in some examples, indicate a downlink BS transmit beam 305 based at least in part on antenna port QCL properties that may be indicated by the TCI state. A TCI state may be associated with one downlink reference signal set (for example, an SSB and an aperiodic, periodic, or semi-persistent channel state information reference signal (CSI-RS)) for different QCL types (for example, QCL types for different combinations of Doppler shift, Doppler spread, average delay, delay spread, or spatial receive parameters, among other examples). In cases where the QCL type indicates spatial receive parameters, the QCL type may correspond to analog receive beamforming parameters of a UE receive beam 310 at the UE 120. Thus, the UE 120 may select a corresponding UE receive beam 310 from a set of BPLs based at least in part on the base station 110 indicating a BS transmit beam 305 via a TCI indication.

The base station 110 may maintain a set of activated TCI states for downlink shared channel transmissions and a set of activated TCI states for downlink control channel transmissions. The set of activated TCI states for downlink shared channel transmissions may correspond to beams that the base station 110 uses for downlink transmission on a PDSCH. The set of activated TCI states for downlink control channel communications may correspond to beams that the base station 110 may use for downlink transmission on a physical downlink control channel (PDCCH) or in a control resource set (CORESET). The UE 120 may also maintain a set of activated TCI states for receiving the downlink shared channel transmissions and the CORESET transmissions. If a TCI state is activated for the UE 120, then the UE 120 may have one or more antenna configurations based at least in part on the TCI state, and the UE 120 may not need to reconfigure antennas or antenna weighting configurations. In some examples, the set of activated TCI states (for example, activated PDSCH TCI states and activated CORESET TCI states) for the UE 120 may be configured by a configuration message, such as a radio resource control (RRC) message.

Similarly, for uplink communications, the UE 120 may transmit in the direction of the base station 110 using a directional UE transmit beam, and the base station 110 may receive the transmission using a directional BS receive beam. Each UE transmit beam may have an associated beam ID, beam direction, or beam symbols, among other examples. The UE 120 may transmit uplink communications via one or more UE transmit beams 315.

The base station 110 may receive uplink transmissions via one or more BS receive beams 320. The base station 110 may identify a particular UE transmit beam 315, shown as UE transmit beam 315-A, and a particular BS receive beam 320, shown as BS receive beam 320-A, that provide relatively favorable performance (for example, that have a best channel quality of the different measured combinations of UE transmit beams 315 and BS receive beams 320). In some examples, the base station 110 may transmit an indication of which UE transmit beam 315 is identified by the base station 110 as a preferred UE transmit beam, which the base station 110 may select for transmissions from the UE 120. The UE 120 and the base station 110 may thus attain and maintain a BPL for uplink communications (for example, a combination of the UE transmit beam 315-A and the BS receive beam 320-A), which may be further refined and maintained in accordance with one or more established beam refinement procedures. An uplink beam, such as a UE transmit beam 315 or a BS receive beam 320, may be associated with a spatial relation. A spatial relation may indicate a directionality or a characteristic of the uplink beam, similar to one or more QCL properties, as described above.

In some cases (e.g., as described in Release 15 of the 3GPP standards), for a PDSCH beam, the UE 120 may be configured with up to 128 TCI states. For example, the UE 120 may receive RRC configuration information that indicates up to 128 TCI states. In some cases, up to 8 TCI states can be activated at a time. For example, the UE 120 may receive a medium access control (MAC) control element (CE) (collectively, MAC-CE) that indicates 8 TCI states to be activated. Each of the TCI states may be mapped to a TCI codepoint. For example, each of the TCI states may be mapped to a TCI codepoint using downlink control information (DCI), such as using DCI formats 0_1 or 0_2. In some cases, the DCI may indicate one of the activated TCI states via a TCI field of the DCI. In some cases, the indication by the DCI may only be for the scheduled PDSCH (e.g., may not be applicable to other PDSCHs).

In some cases, if a time offset is less than a threshold (e.g., a timeDurationForQCL threshold), a default QCL assumption may be used (e.g., for QCL TypeD) for the PDSCH since the UE 120 may not have enough time to decode the DCI and apply the beam determined from the decoding of the DCI (for example, the UE 120 may need to buffer samples with the default QCL assumption and the receiving beam). In some cases, the default QCL assumption for the PDSCH may be the QCL or TCI state of the CORESET, associated with a monitored search space, having the lowest CORESET identifier (CORESET-ID) in the latest slot in which one or more CORESETs within the active bandwidth part (BWP) of the serving cell are monitored by the UE 120.

As indicated above, FIG. 3 is provided as an example. Other examples may differ from what is described with respect to FIG. 3.

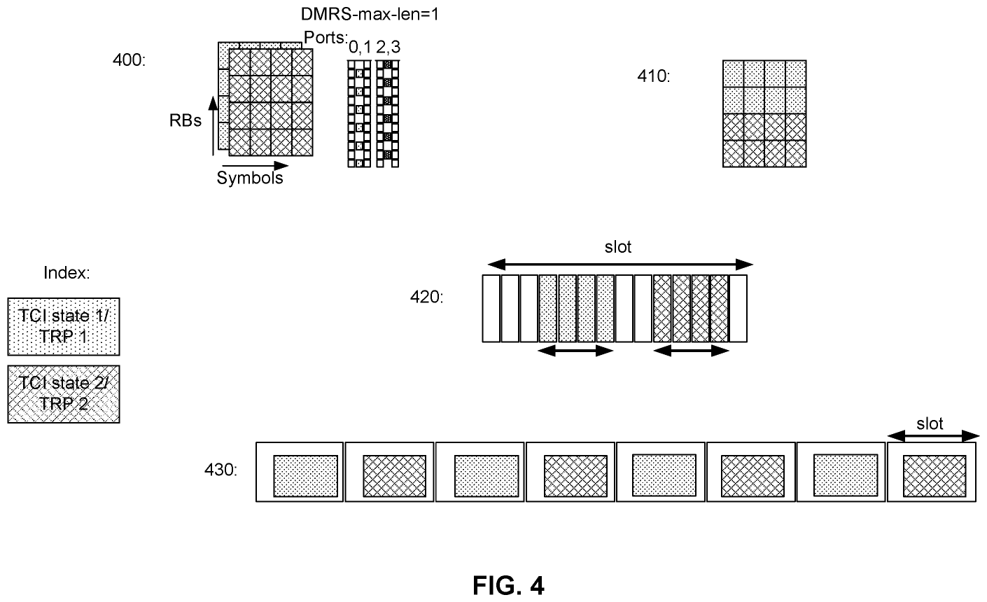

FIG. 4 is a diagram illustrating examples 400, 410, 420, and 430 of communications using a multi-TRP scheme, in accordance with the present disclosure. In some cases (e.g., in Release 16 of the 3GPP standards), the PDSCH may have two TCI states. For example, the PDSCH may have two TCI states for single-DCI based mTRP schemes.

In some cases, as shown in the example 400, the UE 120 may communicate using spatial division multiplexing (SDM). In this case, two TCI states may be used for two sets of layers, or two sets of DMRS ports.

In some cases, as shown in the example 410, the UE 120 may communicate using frequency division multiplexing (FDM). In this case, two TCI states may be used for two sets of resource blocks.

In some cases, as shown in the example 420, the UE 120 may communicate using intra-slot time division multiplexing (TDM). In this case, two DCI states may be used for two repetitions within a slot.

In some cases, as shown in the example 430, the UE 120 may communicate using inter-slot TDM. In this case, two DCI states may be used for multiple (e.g., two or more) repetitions in different slots.

In some cases, the TCI state indications for the schemes shown in examples 400, 410, 420, and/or 430 may be received via DCI that schedules the PDSCH. In some cases, a MAC-CE may activate the TCI states, and may map one or two TCI states to a TCI codepoint. In some cases, the DCI may indicate one TCI codepoint. In some cases, two TCI states may be scheduled if the indicated TCI codepoint is mapped to two TCI states.

In some cases, each TCI codepoint in the DCI (e.g., corresponding to a TCI field value in the DCI) may indicate one TCI state, or two TCI states, for the PDSCH. As described above, a MAC-CE may indicate a mapping if TCI codepoints to the TCI states, and the DCI may indicate one of the TCI codepoints when scheduling the PDSCH. The TCI state(s) corresponding to the indicated TCI codepoints may be used for reception of the PDSCH when the scheduling offset is larger than or equal to a threshold (e.g., timeDurationForQCL). An example of TCI codepoint mapping is shown in Table 1.

TABLE 1
TCI Codepoint Mapping

| TCI Codepoints | TCI States |
|---|---|
| 0 | TCI State ID 3 |
| 1 | TCI State IDs 1 and 4 |
| 2 | TCI State IDs 2 and 6 |
| . . . | . . . |
| 7 | TCI State ID 5 |

In some cases, if at least one TCI codepoint indicates two TCI states, and if the UE 120 is capable and configured with two default TCI states and QCL assumptions (e.g., RRC parameter enableTwoDefaultTC-States), the default QCL assumptions for the PDSCH (e.g., when the time offset is less than timeDurationForQCL) may be the TCI states corresponding to the lowest codepoint among the TCI codepoints containing two different TCI states (e.g., determined from the MAC-CE activation). In the example of Table 1, this may be TCI states 1 and 4 corresponding to codepoint 1.

As indicated above, FIG. 4 is provided as an example. Other examples may differ from what is described with respect to FIG. 4.

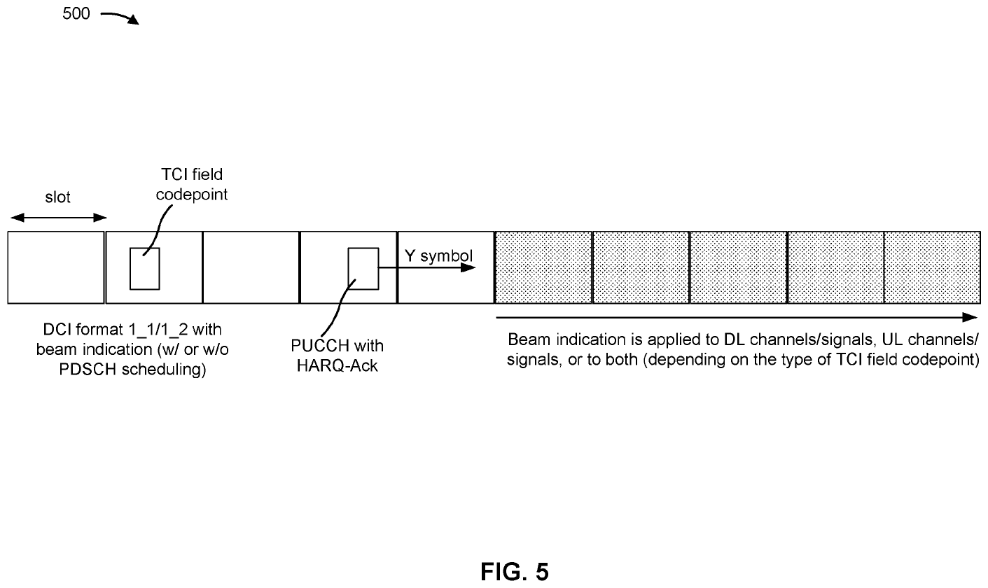

FIG. 5 is a diagram illustrating an example 500 of communications using unified TCI in a single TRP scheme, in accordance with the present disclosure. In some cases (e.g., in Release 17 of the 3GPPP standards), a unified TCI may be RRC configured. In some cases, the unified TCI may include one or more downlink control states, one or more uplink control states, and/or one or more joint uplink and downlink control states that are RRC configured.

In some cases, a MAC-CE may activate one or more RRC configured TCI states, and may map the one or more TCI states to one or more TCI field codepoints, with the following example possibilities:

One TCI field codepoint may represent a joint downlink/uplink TCI state mapped to one TCI codepoint. This may be used for joint downlink/uplink beam indication.

One TCI field codepoint may represent a pair of downlink TCI states and uplink TCI states. This may be used for separate downlink/uplink beam indications.

One TCI field codepoint may represent only a downlink TCI state. This may be used for only downlink beam indication.

One TCI field codepoint may represent only an uplink TCI state. This may be used for only uplink beam indication.

In some cases, if the MAC-CE indicates a mapping to only a single TCI field codepoint, this may serve as the beam indication. For example, 3 ms after the hybrid automatic repeat request (HARQ-ACK) for the PDSCH carrying the MAC-CE is received, the beam indication may be applied.

In some cases, if the MAC-CE indicates a mapping to more than one TCI field codepoint, the downlink DCI (e.g., DCI format 1_1 or 12) with or without downlink assignment information can indicate a beam through the TCI field codepoint. For example, the beam indication may be applied in the first slot that is at least Y symbols (e.g., RRC-configured based on the UE 120 capability) after the last symbol of the physical uplink control channel (PUCCH) carrying the HARQ-ACK in response to the DCI.

In some cases, the Release 17 beam indication may differ from the Release 15/16 beam indication in the following example ways:

The beam indication may be sticky. For example, the beam indication is not related to the scheduled PDSCH, and it is not a one-time indication. When the beam indication is applied, the beam indication remains the same for the applicable channels/signals until another DCI (e.g., DCI format 1_1 or 12) changes the beam.

The beam indication can be for uplink or for both downlink and uplink, even though it is indicated in DCI formats 1_1 and 1_2.

The beam indication may be common for multiple downlink channels and signals (e.g., PDSCH, PDCCH, CSI-RS) and/or multiple uplink channels and signals (e.g., physical uplink shared channel (PUSCH), physical uplink control channel (PUCCH), sounding reference signal (SRS)).

In the Release 16, the beam indication mechanism is only defined for sTRP schemes (with single TCI state), and is not extended to mTRP.

As indicated above, FIG. 5 is provided as an example. Other examples may differ from what is described with respect to FIG. 5.

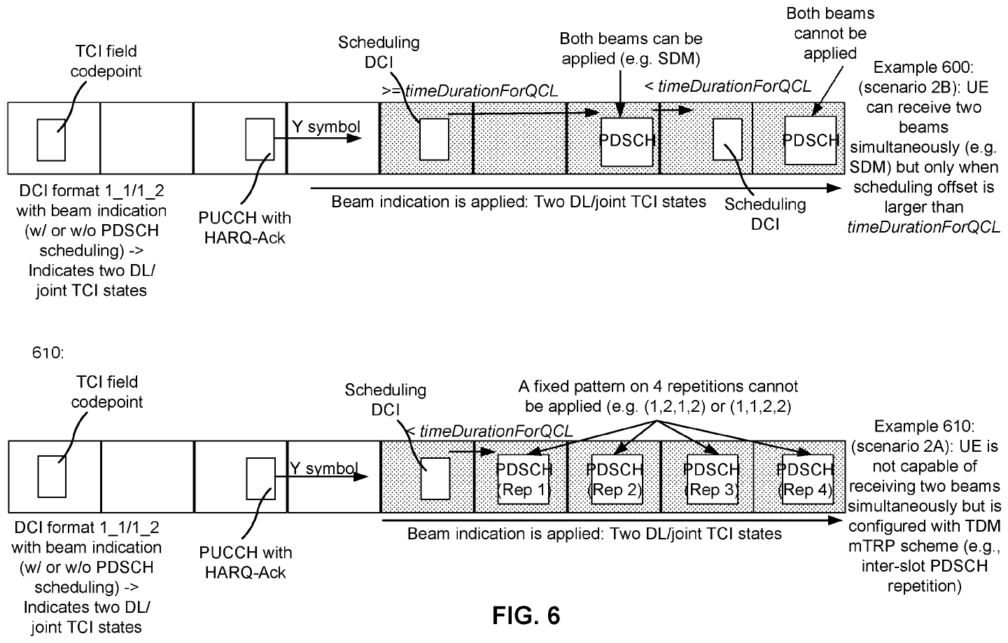

FIG. 6 is a diagram illustrating examples 600 and 610 of communications using unified TCI in a multi-TRP scheme, in accordance with the present disclosure. In some cases (e.g., in Release 18 of the 3GPP standards), the unified TCI described herein may be extended to the mTRP scheme for indicating two TCI states (e.g., two downlink TCI states, two uplink TCI states, two downlink TCI states and two uplink TCI states, or two joint downlink and uplink TCI states, among other examples) for different channels and signals.

In one example, the UE 120 may be capable and configured with two default beams, and the scheduling DCI may schedule the PDSCH with a scheduling offset that is less than a threshold (e.g., timeDurationForQCL).

In one example (e.g., as shown in the example 600), the UE 120 may not be configured with two default beams. For example, the UE 120 may be not capable of receiving two beams simultaneously, and the scheduling DCI may schedule the PDSCH with the scheduling offset that is less than the threshold (e.g., timeDurationForQCL).

In one example (e.g., as shown in the example 610), the UE 120 may be capable of receiving information using two beams simultaneously, but may not be configured with two default beams. For example, the UE 120 may only be configured with a single beam in order to perform power saving, since it may not be desirable to have buffering on two panels (e.g., using two default beams) at all times (e.g., even when there is no scheduling).

In these examples, and in other examples using unified TCI in a multi-TRP scheme, the UE 120 may not be able to determine which beam to use as the default beam, or which beams to use as the default beams, when a pair of TCI states are indicated to be used (e.g., applied) after a specified time for the PDSCH. This may result in communication delays or otherwise lost communications.

Techniques and apparatuses are described herein for PDSCH default beam selection. The UE 120 may receive an indication of a pair of TCI states associated with a PDSCH, and may select a default beam for receiving information via the PDSCH. In some aspects, the UE 120 may be configured to only use one default beam, and the indication may indicate to use the pair of TCI states after a specified time. The UE 120 may be configured to select a beam based at least in part on a value of a TCI state identifier, based at least in part on a value of a control resource set identifier, or based at least in part on RRC information, MAC information, or DCI. In some aspects, the UE 120 may be configured to use two default beams. The UE 120 may be configured to select a pair of default beams indicated by the pair of TCI states, or to select a single default beam indicated by a single TCI state.

As described above, in some examples using unified TCI in the multi-TRP scheme, the UE 120 may not be able to determine which beam to use as the default beam, or which beams to use as the default beams, when a pair of TCI states are indicated to be used (e.g., applied) after a specified time for the PDSCH. Using the techniques and apparatuses described herein, the UE 120 may be configured to select one or more beams as the default beams based at least in part on certain information, such as information received by the UE 120.

As indicated above, FIG. 6 is provided as an example. Other examples may differ from what is described with respect to FIG. 6.

FIG. 7 is a diagram illustrating an example 700 of PDSCH default beam selection, in accordance with the present disclosure. A UE, such as the UE 120, may be configured to communicate with a base station, such as the base station 110. As described herein, the base station 110 may be a TRP.

As shown in connection with reference number 705, the base station 110 may transmit, and the UE 120 may receive, an indication of a pair of TCI states associated with a PDSCH. As described herein, each of the pair of TCI states may indicate a directionality, or a characteristic, of the PDSCH, such as a QCL property of the PDSCH. In some aspects, the pair of TCI states may be associated with a codepoint. For example, a first codepoint may correspond to a first pair of the TCI states, and a second codepoint may correspond to a second pair of the TCI states, among other examples.

As shown in connection with reference number 710, the UE 120 may select a default beam for receiving information via the PDSCH in accordance with a single default beam configuration.

In some aspects, the UE 120 may not be capable of receiving information via the PDSCH using two beams, and/or may not be configured with two beams. However, the UE 120 may receive a pair of TCI states that are indicated to be applied starting from a given time.

In some aspects, the UE 120 may select one default beam (e.g., a single default beam) for the case that the offset between the scheduling DCI and the PDSCH is less than a threshold (e.g., timeDurationForQCL).

In one example, the UE 120 may select a default beam based at least in part on a value of the TCI state, of the pair of TCI states. For example, the UE 120 may determine that a first TCI state, of the pair of TCI states, has a value that is lower than a value of a second TCI state, of the pair of TCI states. Thus, the UE 120 may select the beam associated with the first TCI state. In this example, the same default beam may be used in all slots (e.g., after receiving the beam indication and/or until another beam indication is received).

In one example, the default beam may be selected based at least in part on information received by the UE 120. For example, the UE 120 may receive RRC information (e.g., configuration information), MAC information (e.g., a MAC-CE that activates the TCI states), or DCI information (e.g., other than the scheduling DCI information). The UE 120 may select the default beam based at least in part on the RRC information, the MAC information, or the DCI. In this example, the same default beam may be used in all slots (e.g., after receiving the beam indication and/or until another beam indication is received).

In one example, the UE 120 may select a default beam based at least in part on a control resource set identifier (CORESET-ID). For example, the UE 120 may select a beam associated with the lowest CORESET-ID as the default beam. In this example, different beams may be used in different slots, depending on whether the beam indication is applied to the PDCCH or the CORESET, or how the beam indication is applied to the PDCCH or the CORESET (e.g., if the two TCI states of the beam indication are applied to two groups of CORESETs, respectively).

In some aspects (e.g., in the examples described above), when the offset between the scheduling DCI and the PDSCH is less than the threshold (e.g., timeDurationForQCL), the mTRP scheme may not be able to be scheduled, and the sTRP scheme with the default beam may be used.

In some aspects, the indication may indicate to use (e.g., apply) the pair of TCI states from a slot (e.g., slot n) in a TDM manner based at least in part on a pattern. The pattern may be applied irrespective of the scheduling DCI. In some aspects, the pattern may be applied at the slot level. For example, the UE 120 may alternate each slot between the first TCI state and the second TCI state. In some aspects, the pattern may be applied at the symbol level. For example, the UE 120 may alternate each symbol between the first TCI state and the second TCI state. In some aspects, the pattern may be applied at the mini-slot level. For example, the UE 120 may alternate each mini-slot between the first TCI state and the second TCI state.

In one example, the pattern may be used irrespective of the scheduling offset (e.g., the default beam is the same as the beam indication in a given slot). In this example, it may not be possible to schedule the sTRP PDSCH with inter-slot PDSCH repetition (e.g., with the same beam) if the pattern has different beams in those slots. Additionally, or alternatively, it may not be possible to schedule the PDSCH in a slot with a different beam than the beam of the pattern.

In one example, the pattern may be used only when the PDSCH scheduled with the scheduling offset is smaller than the threshold (e.g., timeDurationForQCL). Here, the pattern may not be used when the scheduling offset is greater than the threshold. In some cases, one of the TCI states, of the pair of TCI states, may be used, but not necessarily according to the pattern. In this example, it may be possible to schedule the sTRP PDSCH with any one of the two TCI states of the pair in any slot. Additionally, or alternatively, it may be possible to schedule the mTRP PDSCH with a different order of the two TCI states of the pair as long as the scheduling offset is greater than or equal to the threshold.

In some aspects, the pattern may be fixed. The pattern may be fixed and always applied when the two TCI states are indicated (e.g., if the UE 120 is not capable or configured with two default beams). For example, the UE 120 may apply the first TCI state of the indicated pair in slots n, n+2, n+4, . . . , and may apply the second TCI state of the indicated pair in slots n+1, n+3, n+5, . . . .

In some aspects, the pattern may be RRC configured. For example, the pattern may be RRC configured (e.g., cyclic 1212 . . . , sequential 11221122 . . . , or more flexible patterns) starting from the first slot in which the beam indication applies (e.g., irrespective of MAC-CE or beam indication DCI).

In some aspects, the pattern may be indicated by a MAC-CE. For example, the pattern may be indicated in the MAC-CE that activates TCI states and maps to the TCI codepoint (which may be common to all TCI codepoints (e.g., irrespective of the beam indication DCI)).

In some aspects, the pattern may be indicated by DCI. For example, the pattern may be indicated as part of the TCI codepoint of the beam indication DCI (e.g., the MAC-CE can map one TCI codepoint (TCI state 1, TCI state 2, pattern x) to another TCI codepoint (TCI state 3, TCI state 2, pattern y), and the DCI may indicate one of the codepoints).

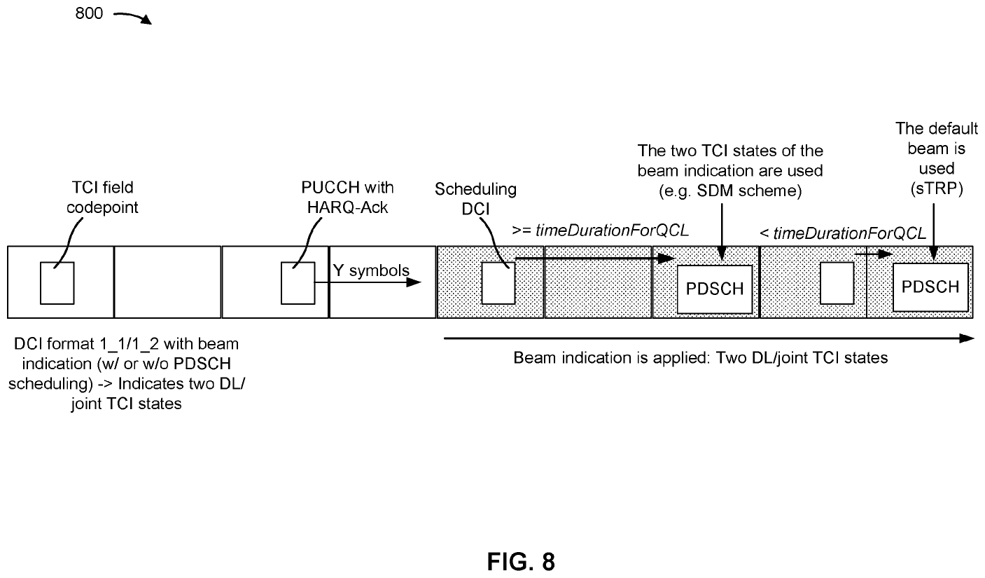

Additional details regarding these features are described below in connection with FIG. 8-10.

As shown in connection with reference number 715, the UE 120 may select one or more default beams for receiving information via the PDSCH in accordance with a two default beam configuration. In some aspects, the UE 120 may be configured (e.g., via an RRC configuration) with two default beams. For example, the UE 120 may be configured, via the RRC parameter enableTwoDefaultTCI-States, with the two default beams.

In some aspects, when a pair of TCI states (e.g., downlink/joint) are indicated to be applied starting from a given time, the two default beams may be the same as the two indicated TCI states. In some aspects, when one downlink or joint TCI state is indicated to be applied starting from a given time, the UE 120 may not assume two default beams, and may apply a single default beam (e.g., only one default beam). For example, the UE 120 may apply the single default beam corresponding to the single downlink or joint TCI state. This is in contrast to the default beam selection process described above in connection with the Release 16, where the two default beams were selected (e.g., after MAC-CE activation) based at least in part on the two TCI states corresponding to the lowest codepoint among the TCI codepoints containing two different TCI states.

As indicated above, FIG. 7 is provided as an example. Other examples may differ from what is described with respect to FIG. 7.

FIG. 8 is a diagram illustrating an example 800 of default beam selection for single beam PDSCH, in accordance with the present disclosure.

As described above, in some aspects, the UE 120 may select one default beam (e.g., a single default beam) for the case that the offset between the scheduling DCI and the PDSCH is less than a threshold (e.g., timeDurationForQCL). In one example, the UE 120 may select a default beam based at least in part on a value of the TCI state, of the pair of TCI states. In another example, the default beam may be selected based at least in part on information received by the UE 120. In another example, the UE 120 may select a default beam based at least in part on a control resource set identifier (CORESET-ID).

As shown in the example 800, a DCI format 1_1/1_2 with a beam indication (with or without PDSCH scheduling) may be received. The DCI may indicate two downlink/joint TCI states. When the offset between the scheduling DCI and the PDSCH is greater than or equal to a threshold (e.g., timeDurationForQCL), the two TCI states of the beam indication may be used (e.g., SDM scheme). In contrast, when the offset between the scheduling DCI and the PDSCH is less than the threshold, the default beam may be used (e.g., for sTRP).

As indicated above, FIG. 8 is provided as an example. Other examples may differ from what is described with respect to FIG. 8.

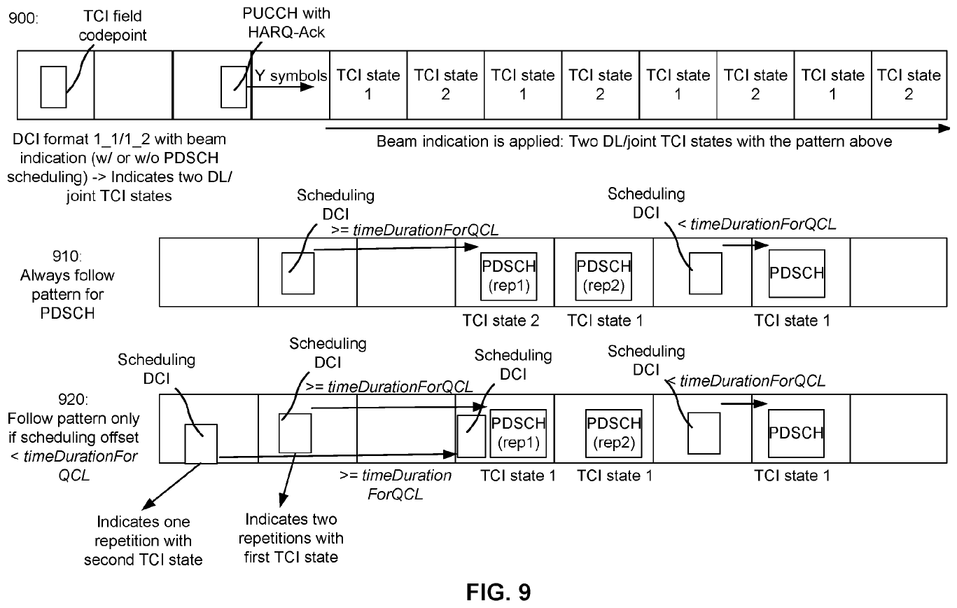

FIG. 9 is a diagram illustrating examples 900, 910, and 920 of default beam selection for PDSCH pattern, in accordance with the present disclosure.

As shown in the example 900, a DCI format 1_1/1_2 with a beam indication (with or without PDSCH scheduling) may be received. The DCI may indicate two downlink/joint TCI states. In some aspects, the indication may indicate to use (e.g., apply) the pair of TCI states from a slot (e.g., slot n) in a TDM manner based at least in part on a pattern. The pattern may be applied irrespective of the scheduling DCI. The pattern may be applied at the slot level, at the symbol level, or at the mini-slot level.

As shown in the example 910, the pattern may be used irrespective of the scheduling offset (e.g., the default beam is the same as the beam indication in a given slot). In this example, it may not be possible to schedule the sTRP PDSCH with inter-slot PDSCH repetition (e.g., with the same beam) if the pattern has different beams in those slots. Additionally, or alternatively, it may not be possible to schedule the PDSCH in a slot with a different beam than the beam of the pattern.

As shown in the example 920, the pattern may be used only when the PDSCH scheduled with the scheduling offset is smaller than the threshold (e.g., timeDurationForQCL). Here, the pattern may not be used when the scheduling offset is greater than the threshold. In some cases, one of the TCI states, of the pair of TCI states, may be used, but not necessarily according to the pattern. In this example, it may be possible to schedule the sTRP PDSCH with any one of the two TCI states of the pair in any slot. Additionally, or alternatively, it may be possible to schedule the mTRP PDSCH with a different order of the two TCI states of the pair as long as the scheduling offset is greater than or equal to the threshold.

As indicated above, FIG. 9 is provided as an example. Other examples may differ from what is described with respect to FIG. 9.

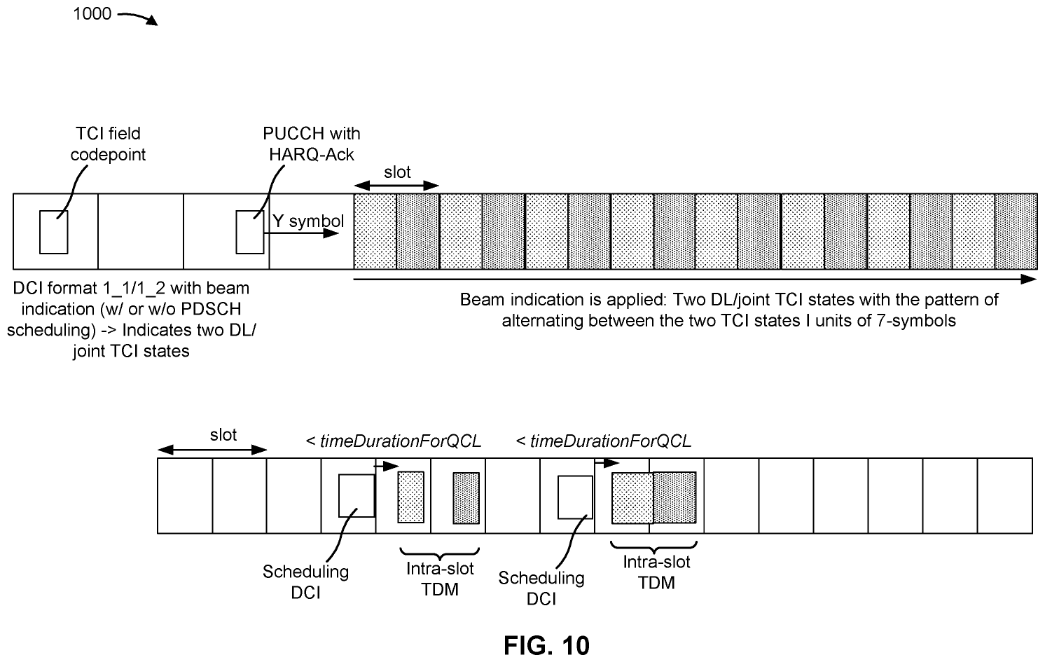

FIG. 10 is a diagram illustrating an example 1000 of beam selection for an intra-slot PDSCH scheme, in accordance with the present disclosure.

In some aspects, an intra-slot TDM PDSCH scheme (tdmSchemeA) may be enabled when the scheduling offset is smaller than the threshold (e.g., timeDurationForQCL). For example, a pattern may be defined at the symbol level (e.g., in units of 7-symbols), and the time domain resource allocation (TDRA) indication of the scheduling DCI may be restricted not to cross the boundary of the pattern. For the tdmSchemeA, the TDRA may indicate the start and length indicator value (SLIV) for the first repetition in the slot. The second repetition may have the same length, and may start X symbols after the end of the first repetition (where X is RRC-configured, or X=0 if not configured). Both the first repetition and the second repetition should be in the same slot.

As indicated above, FIG. 10 is provided as an example. Other examples may differ from what is described with respect to FIG. 10.

FIG. 11 is a diagram illustrating an example process 1100 performed, for example, by a UE, in accordance with the present disclosure. Example process 1100 is an example where the UE (e.g., UE 120) performs operations associated with PDSCH default beam selection.

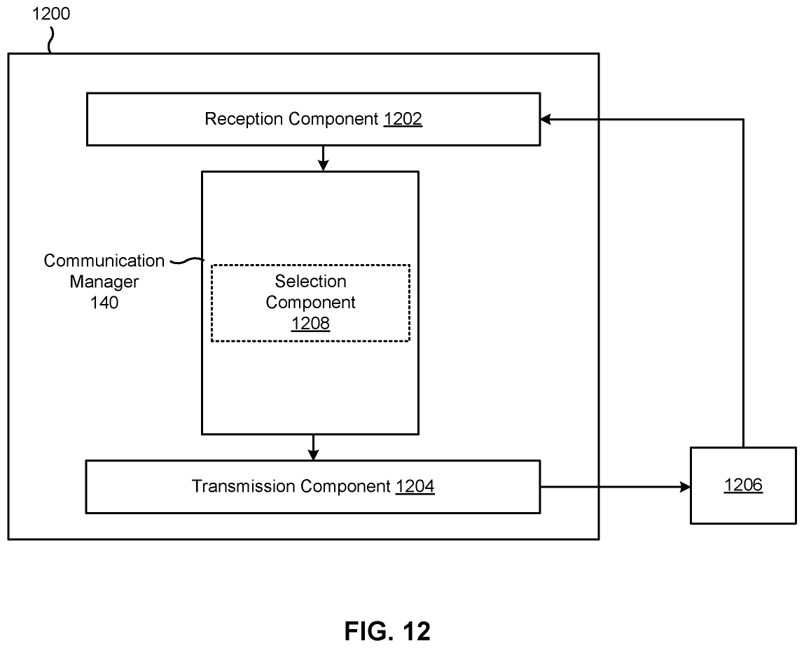

As shown in FIG. 11, in some aspects, process 1100 may include receiving an indication of a pair of TCI states associated with a PDSCH (block 1110). For example, the UE (e.g., using communication manager 140 and/or reception component 1202, depicted in FIG. 12) may receive an indication of a pair of TCI states associated with a PDSCH, as described above.

As further shown in FIG. 11, in some aspects, process 1100 may include selecting, based at least in part on the indication, a default beam for receiving information via the PDSCH (block 1120). For example, the UE (e.g., using communication manager 140 and/or selection component 1208, depicted in FIG. 12) may select, based at least in part on the indication, a default beam for receiving information via the PDSCH, as described above.

Process 1100 may include additional aspects, such as any single aspect or any combination of aspects described below and/or in connection with one or more other processes described elsewhere herein.

In a first aspect, the UE is configured to use only one default beam, and the indication indicates to use the pair of TCI states after a specified time.

In a second aspect, alone or in combination with the first aspect, selecting the default beam comprises selecting a beam associated with a first TCI state, of the pair of TCI states, as the default beam for receiving information via the PDSCH.

In a third aspect, alone or in combination with one or more of the first and second aspects, selecting the default beam comprises selecting a beam associated with a TCI state identifier, of a pair of TCI state identifiers associated with the pair of TCI states, having a lowest value, as the default beam for receiving information via the PDSCH.

In a fourth aspect, alone or in combination with one or more of the first through third aspects, selecting the default beam is based at least in part on radio resource control configuration information, medium access control information, or downlink control information.

In a fifth aspect, alone or in combination with one or more of the first through fourth aspects, selecting the default beam comprises selecting a beam associated with a control resource set, of a plurality of control resource sets of a most recently monitored slot, with a lowest control resource set identifier, as the default beam for receiving information via the PDSCH.

In a sixth aspect, alone or in combination with one or more of the first through fifth aspects, selecting the default beam comprises selecting a beam having a first TCI state, of the pair of TCI states, and a beam having a second TCI state, of the pair of TCI states, for receiving information via the PDSCH in accordance with a pattern.

In a seventh aspect, alone or in combination with one or more of the first through sixth aspects, the pattern is a time division multiplexing pattern.

In an eighth aspect, alone or in combination with one or more of the first through seventh aspects, the pattern is a slot-level pattern, a symbol-level pattern, or a mini-slot level pattern.

In a ninth aspect, alone or in combination with one or more of the first through eighth aspects, process 1100 includes receiving the information via the PDSCH, in accordance with the pattern, regardless of a scheduling offset.

In a tenth aspect, alone or in combination with one or more of the first through ninth aspects, process 1100 includes receiving the information via the PDSCH, in accordance with the pattern, only if a scheduling offset is less than a threshold.

In an eleventh aspect, alone or in combination with one or more of the first through tenth aspects, the pattern is a fixed pattern.

In a twelfth aspect, alone or in combination with one or more of the first through eleventh aspects, the pattern is configured via radio resource control information.

In a thirteenth aspect, alone or in combination with one or more of the first through twelfth aspects, the pattern is indicated in a medium access control message that activates the pair of TCI states and that corresponds to a plurality of TCI codepoints.

In a fourteenth aspect, alone or in combination with one or more of the first through thirteenth aspects, the pattern is associated with a TCI codepoint, and is indicated in downlink control information.

In a fifteenth aspect, alone or in combination with one or more of the first through fourteenth aspects, the UE is configured to use two default beams.

In a sixteenth aspect, alone or in combination with one or more of the first through fifteenth aspects, the indication of the pair of TCI states indicates to use the pair of TCI states after a specified time, and selecting the default beam for receiving the information via the PDSCH comprises selecting a pair of beams indicated by the pair of TCI states.

In a seventeenth aspect, alone or in combination with one or more of the first through sixteenth aspects, the indication of the pair of TCI states indicates to use a single TCI state after a specified time, and selecting the default beam for receiving the information via the PDSCH comprises selecting the beam indicated by the single TCI state.

In an eighteenth aspect, alone or in combination with one or more of the first through seventeenth aspects, process 1100 includes receiving a plurality of TCI codepoints, each of the TCI codepoints indicating a pair of TCI states, of a plurality of TCI states.

In a nineteenth aspect, alone or in combination with one or more of the first through eighteenth aspects, a first TCI codepoint indicates a pair of joint downlink and uplink TCI states, a second TCI codepoint indicates a pair of downlink TCI states and a pair of uplink TCI states, a third TCI codepoint indicates a pair of downlink TCI states, and a fourth TCI codepoint indicates a pair of uplink TCI states.

In a twentieth aspect, alone or in combination with one or more of the first through nineteenth aspects, process 1100 includes receiving an RRC configuration that indicates a plurality of TCI states.

In a twenty-first aspect, alone or in combination with one or more of the first through twentieth aspects, the indication of the pair of TCI states is received via downlink control information.

Although FIG. 11 shows example blocks of process 1100, in some aspects, process 1100 may include additional blocks, fewer blocks, different blocks, or differently arranged blocks than those depicted in FIG. 11. Additionally, or alternatively, two or more of the blocks of process 1100 may be performed in parallel.

FIG. 12 is a diagram of an example apparatus 1200 for wireless communication. The apparatus 1200 may be a UE, or a UE may include the apparatus 1200. In some aspects, the apparatus 1200 includes a reception component 1202 and a transmission component 1204, which may be in communication with one another (for example, via one or more buses and/or one or more other components). As shown, the apparatus 1200 may communicate with another apparatus 1206 (such as a UE, a base station, or another wireless communication device) using the reception component 1202 and the transmission component 1204. As further shown, the apparatus 1200 may include the communication manager 140. The communication manager 140 may include a selection component 1208, among other examples.

In some aspects, the apparatus 1200 may be configured to perform one or more operations described herein in connection with FIGS. 7-10. Additionally, or alternatively, the apparatus 1200 may be configured to perform one or more processes described herein, such as process 1100 of FIG. 11. In some aspects, the apparatus 1200 and/or one or more components shown in FIG. 12 may include one or more components of the UE described in connection with FIG. 2. Additionally, or alternatively, one or more components shown in FIG. 12 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1202 may receive communications, such as reference signals, control information, data communications, or a combination thereof, from the apparatus 1206. The reception component 1202 may provide received communications to one or more other components of the apparatus 1200. In some aspects, the reception component 1202 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1200. In some aspects, the reception component 1202 may include one or more antennas, a modem, a demodulator, a MIMO detector, a receive processor, a controller/processor, a memory, or a combination thereof, of the UE described in connection with FIG. 2.

The transmission component 1204 may transmit communications, such as reference signals, control information, data communications, or a combination thereof, to the apparatus 1206. In some aspects, one or more other components of the apparatus 1200 may generate communications and may provide the generated communications to the transmission component 1204 for transmission to the apparatus 1206. In some aspects, the transmission component 1204 may perform signal processing on the generated communications (such as filtering, amplification, modulation, digital-to-analog conversion, multiplexing, interleaving, mapping, or encoding, among other examples), and may transmit the processed signals to the apparatus 1206. In some aspects, the transmission component 1204 may include one or more antennas, a modem, a modulator, a transmit MIMO processor, a transmit processor, a controller/processor, a memory, or a combination thereof, of the UE described in connection with FIG. 2. In some aspects, the transmission component 1204 may be co-located with the reception component 1202 in a transceiver.

The reception component 1202 may receive an indication of a pair of TCI states associated with a PDSCH. The selection component 1208 may select, based at least in part on the indication, a default beam for receiving information via the PDSCH.

The reception component 1202 may receive the information via the PDSCH, in accordance with the pattern, regardless of a scheduling offset.

The reception component 1202 may receive the information via the PDSCH, in accordance with the pattern, only if a scheduling offset is less than a threshold.

The reception component 1202 may receive a plurality of TCI codepoints, each of the TCI codepoints indicating a pair of TCI states, of a plurality of TCI states.

The reception component 1202 may receive an RRC configuration that indicates a plurality of TCI states.

The number and arrangement of components shown in FIG. 12 are provided as an example. In practice, there may be additional components, fewer components, different components, or differently arranged components than those shown in FIG. 12. Furthermore, two or more components shown in FIG. 12 may be implemented within a single component, or a single component shown in FIG. 12 may be implemented as multiple, distributed components. Additionally, or alternatively, a set of (one or more) components shown in FIG. 12 may perform one or more functions described as being performed by another set of components shown in FIG. 12.

The following provides an overview of some Aspects of the present disclosure:

Aspect 1: A method of wireless communication performed by a user equipment (UE), comprising: receiving an indication of a pair of transmission configuration indication (TCI) states associated with a physical downlink shared channel (PDSCH); and selecting, based at least in part on the indication, a default beam for receiving information via the PDSCH.

Aspect 2: The method of Aspect 1, wherein the UE is configured to use only one default beam, and wherein the indication indicates to use the pair of TC states after a specified time.

Aspect 3: The method of Aspect 2, wherein selecting the default beam comprises selecting a beam associated with a first TCI state, of the pair of TC states, as the default beam for receiving information via the PDSCH.

Aspect 4: The method of Aspect 2, wherein selecting the default beam comprises selecting a beam associated with a TCI state identifier, of a pair of TC state identifiers associated with the pair of TC states, having a lowest value, as the default beam for receiving information via the PDSCH.

Aspect 5: The method of Aspect 2, wherein selecting the default beam is based at least in part on radio resource control configuration information, medium access control information, or downlink control information.

Aspect 6: The method of Aspect 2, wherein selecting the default beam comprises selecting a beam associated with a control resource set, of a plurality of control resource sets of a most recently monitored slot, with a lowest control resource set identifier, as the default beam for receiving information via the PDSCH.

Aspect 7: The method of Aspect 2, wherein selecting the default beam comprises selecting a beam having a first TCI state, of the pair of TC states, and a beam having a second TCI state, of the pair of TC states, for receiving information via the PDSCH in accordance with a pattern.

Aspect 8: The method of Aspect 7, wherein the pattern is a time division multiplexing pattern.

Aspect 9: The method of Aspect 7, wherein the pattern is a slot-level pattern, a symbol-level pattern, or a mini-slot level pattern.

Aspect 10: The method of Aspect 7, further comprising receiving the information via the PDSCH, in accordance with the pattern, regardless of a scheduling offset.

Aspect 11: The method of Aspect 7, further comprising receiving the information via the PDSCH, in accordance with the pattern, only if a scheduling offset is less than a threshold.

Aspect 12: The method of Aspect 7, wherein the pattern is a fixed pattern.

Aspect 13: The method of Aspect 7, wherein the pattern is configured via radio resource control information.

Aspect 14: The method of Aspect 7, wherein the pattern is indicated in a medium access control message that activates the pair of TC states and that corresponds to a plurality of TCI codepoints.

Aspect 15: The method of Aspect 7, wherein the pattern is associated with a TCI codepoint, and is indicated in downlink control information.

Aspect 16: The method of any of Aspects 1-15, wherein the UE is configured to use two default beams.

Aspect 17: The method of Aspect 16, wherein the indication of the pair of TC states indicates to use the pair of TC states after a specified time, and wherein selecting the default beam for receiving the information via the PDSCH comprises selecting a pair of beams indicated by the pair of TC states.

Aspect 18: The method of Aspect 16, wherein the indication of the pair of TC states indicates to use a single TCI state after a specified time, and wherein selecting the default beam for receiving the information via the PDSCH comprises selecting the beam indicated by the single TCI state.

Aspect 19: The method of any of Aspects 1-18, further comprising receiving a plurality of TC codepoints, each of the TCI codepoints indicating a pair of TC states, of a plurality of TC states.

Aspect 20: The method of Aspect 19, wherein a first TCI codepoint indicates a pair of joint downlink and uplink TCI states; a second TCI codepoint indicates a pair of downlink TCI states and a pair of uplink TCI states; a third TCI codepoint indicates a pair of downlink TCI states; and a fourth TCI codepoint indicates a pair of uplink TCI states.

Aspect 21: The method of any of Aspects 1-20, further comprising receiving an RRC configuration that indicates a plurality of TC states.

Aspect 22: The method of any of Aspects 1-21, wherein the indication of the pair of TCI states is received via downlink control information.

Aspect 23: An apparatus for wireless communication at a device, comprising a processor; memory coupled with the processor; and instructions stored in the memory and executable by the processor to cause the apparatus to perform the method of one or more of Aspects 1-22.

Aspect 24: A device for wireless communication, comprising a memory and one or more processors coupled to the memory, the one or more processors configured to perform the method of one or more of Aspects 1-22.

Aspect 25: An apparatus for wireless communication, comprising at least one means for performing the method of one or more of Aspects 1-22.

Aspect 26: A non-transitory computer-readable medium storing code for wireless communication, the code comprising instructions executable by a processor to perform the method of one or more of Aspects 1-22.

Aspect 27: A non-transitory computer-readable medium storing a set of instructions for wireless communication, the set of instructions comprising one or more instructions that, when executed by one or more processors of a device, cause the device to perform the method of one or more of Aspects 1-22.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. An apparatus for wireless communication at a user equipment (UE), comprising:
a memory; and
one or more processors, coupled to the memory, configured to:
receive an indication of a pair of transmission configuration indication (TCI) states associated with a physical downlink shared channel (PDSCH); and
select, based at least in part on the indication, a default beam for receiving information via the PDSCH.

2. The apparatus of claim 1, wherein the UE is configured to use only one default beam, and wherein the indication indicates to use the pair of TC states after a specified time.

3. The apparatus of claim 2, wherein the one or more processors, to select the default beam, are configured to select a beam associated with a first TCI state, of the pair of TC states, as the default beam for receiving information via the PDSCH.

4. The apparatus of claim 2, wherein the one or more processors, to select the default beam, are configured to select a beam associated with a TCI state identifier, of a pair of TC state identifiers associated with the pair of TC states, having a lowest value, as the default beam for receiving information via the PDSCH.

5. The apparatus of claim 2, wherein selecting the default beam is based at least in part on radio resource control configuration information, medium access control information, or downlink control information.

6. The apparatus of claim 2, wherein the one or more processors, to select the default beam, are configured to select a beam associated with a control resource set, of a plurality of control resource sets of a most recently monitored slot, with a lowest control resource set identifier, as the default beam for receiving information via the PDSCH.

7. The apparatus of claim 2, wherein the one or more processors, to select the default beam, are configured to select a beam having a first TCI state, of the pair of TC states, and a beam having a second TCI state, of the pair of TC states, for receiving information via the PDSCH in accordance with a pattern.

8. The apparatus of claim 7, wherein the pattern is a time division multiplexing pattern.

9. The apparatus of claim 7, wherein the pattern is a slot-level pattern, a symbol-level pattern, or a mini-slot level pattern.

10. The apparatus of claim 7, wherein the one or more processors are further configured to receive the information via the PDSCH, in accordance with the pattern, regardless of a scheduling offset.

11. The apparatus of claim 7, wherein the one or more processors are further configured to receive the information via the PDSCH, in accordance with the pattern, only if a scheduling offset is less than a threshold.

12. The apparatus of claim 7, wherein the pattern is a fixed pattern.

13. The apparatus of claim 7, wherein the pattern is configured via radio resource control information.

14. The apparatus of claim 7, wherein the pattern is indicated in a medium access control message that activates the pair of TC states and that corresponds to a plurality of TC codepoints.

15. The apparatus of claim 7, wherein the pattern is associated with a TCI codepoint, and is indicated in downlink control information.

16. The apparatus of claim 1, wherein the UE is configured to use two default beams.

17. The apparatus of claim 16, wherein the indication of the pair of TC states indicates to use the pair of TC states after a specified time, and wherein selecting the default beam for receiving the information via the PDSCH comprises selecting a pair of beams indicated by the pair of TC states.

18. The apparatus of claim 16, wherein the indication of the pair of TC states indicates to use a single TCI state after a specified time, and wherein selecting the default beam for receiving the information via the PDSCH comprises selecting the beam indicated by the single TCI state.

19. The apparatus of claim 1, wherein the one or more processors are further configured to receive a plurality of TC codepoints, each of the TCI codepoints indicating a pair of TC states, of a plurality of TC states.

20. The apparatus of claim 19, wherein:
a first TCI codepoint indicates a pair of joint downlink and uplink TCI states;
a second TCI codepoint indicates a pair of downlink TCI states and a pair of uplink TCI states;
a third TCI codepoint indicates a pair of downlink TCI states; and
a fourth TCI codepoint indicates a pair of uplink TCI states.

21. A method of wireless communication performed by a user equipment (UE), comprising:
receiving an indication of a pair of transmission configuration indication (TCI) states associated with a physical downlink shared channel (PDSCH); and
selecting, based at least in part on the indication, a default beam for receiving information via the PDSCH.

22. The method of claim 21, wherein the UE is configured to use only one default beam, and wherein the indication indicates to use the pair of TC states after a specified time.

23. The method of claim 22, wherein selecting the default beam comprises selecting a beam associated with a first TCI state, of the pair of TC states, as the default beam for receiving information via the PDSCH.

24. The method of claim 22, wherein selecting the default beam comprises selecting a beam associated with a TCI state identifier, of a pair of TC state identifiers associated with the pair of TCI states, having a lowest value, as the default beam for receiving information via the PDSCH.

25. The method of claim 22, wherein selecting the default beam is based at least in part on radio resource control configuration information, medium access control information, or downlink control information.

26. The method of claim 22, wherein selecting the default beam comprises selecting a beam associated with a control resource set, of a plurality of control resource sets of a most recently monitored slot, with a lowest control resource set identifier, as the default beam for receiving information via the PDSCH.

27. The method of claim 22, wherein selecting the default beam comprises selecting a beam having a first TCI state, of the pair of TC states, and a beam having a second TCI state, of the pair of TC states, for receiving information via the PDSCH in accordance with a pattern.

28. The method of claim 27, wherein the pattern is a time division multiplexing pattern.

29. The method of claim 27, wherein the pattern is a slot-level pattern, a symbol-level pattern, or a mini-slot level pattern.

30. The method of claim 21, wherein the UE is configured to use two default beams.

31. The method of claim 30, wherein the indication of the pair of TC states indicates to use the pair of TC states after a specified time, and wherein selecting the default beam for receiving the information via the PDSCH comprises selecting a pair of beams indicated by the pair of TC states.

32. The method of claim 30 wherein the indication of the pair of TC states indicates to use a single TCI state after a specified time, and wherein selecting the default beam for receiving the information via the PDSCH comprises selecting the beam indicated by the single TCI state.

33. The method of claim 21, further comprising receiving a plurality of TC codepoints, each of the TCI codepoints indicating a pair of TC states, of a plurality of TC states.

34. A non-transitory computer-readable medium storing a set of instructions for wireless communication, the set of instructions comprising:
one or more instructions that, when executed by one or more processors of a user equipment (UE), cause the UE to:
receive an indication of a pair of transmission configuration indication (TCI) states associated with a physical downlink shared channel (PDSCH); and
select, based at least in part on the indication, a default beam for receiving information via the PDSCH.

35. An apparatus for wireless communication, comprising:
means for receiving an indication of a pair of transmission configuration indication (TCI) states associated with a physical downlink shared channel (PDSCH); and
means for selecting, based at least in part on the indication, a default beam for receiving information via the PDSCH.
